(19) United States
(12) Patent Application Publication
(10) Pub. No.: US 2023/0331472 A1
(43) Pub. Date: Oct. 19, 2023

(54) SMART TRASH CAN

(71) Applicant: MAXTON ENGINEERING LTD., Central (HK)

(72) Inventor: Shou Qiang ZHU, La Verne, CA (US)

(21) Appl. No.: 18/179,273

(22) Filed: Mar. 6, 2023

Related U.S. Application Data
(60) Provisional application No. 63/316,963, filed on Mar. 4, 2022.

(51) Int. Cl. B65F 1/06; B65F 1/14; B65F 1/16

(52) U.S. Cl. CPC B65F 1/062; B65F 1/065; B65F 1/14; B65F 1/16; B65F 2210/137; B65F 2210/168; B65F 2210/179

(57) ABSTRACT

A smart trash can having a housing with a front housing door pivotable to tilt to a tilted open position. A bucket is attached to the housing door to tilt along with tilting of the housing door. A trash bag liner cartridge is supported below a housing lid within a crown of the housing. The liner cartridge stores a supply of liner material for trash bag replacements. A bag sealing and cutting mechanism seals a top opening of a filled trash bag and separates the liner material supplied from the liner cartridge upon tilting the housing door to the tilted open position, and seals an open bottom end of the liner material supplied from the liner cartridge. A bag relining mechanism lines the interior walls of the bucket with the liner material upon removal of the filled trash bag and closure of the housing door from its tilted open position.

### PRIORITY CLAIM

This application claims the priorities of U.S. Provisional Patent Application No. 63/316,963 filed on Mar. 4, 2022. This application is fully incorporated by reference as if fully set forth herein. All publications noted below are fully incorporated by reference as if fully set forth herein.

### FIELD OF THE INVENTION

The present invention is directed to trash can, and more particularly to a trash can with smart automatic features and smart functions.

### BACKGROUND OF THE INVENTION

Heretofore, trash receptacles are fitted with a disposable trash bag liner. Trash receptacles that employ such liners include household kitchen garbage canisters, office trash cans, etc. (collectively “trash cans”). Hereinafter, reference made to trash can include trash canisters and other receptacles in the context discussed below. The trash canisters are typically made from a rigid material like plastic or metal. The bags intended to be used as liners for such refuse containers are typically made from low-cost, pliable or flexible plastic material. When the canister is full, the plastic liner that is holding the trash may be removed for further disposal and replaced with a new liner.

When being utilized as a trash canister liner, it is important that the bag be secured in a manner that the bag can extend vertically within the canister, so that items placed into the canister fall and collect at the bottom of the bag. Additionally, it is important that the bag does not unsecure or release itself with respect to the trash canister, so as to fall into the trash canister. To avoid this problem, the open circumference of the bag is often folded over the lip or rim of the trash canister and may be tied thereto in order to retain the trash bag to the trash canister.

Heretofore, trash cans for use in kitchen and/or toilets (or anywhere unpleasant odors from trash in the trash cans are to be reduced) are provided with lids. Some trash cans are provided with lids that can open and close automatically. It has been an inconvenient and time-consuming process for a user to try to fit and secure a trash bag to the trash can, especially tall kitchen trash can. Some tall kitchen trash cans are provided with a removable hard plastic bucket therein, in which a disposable plastic trash bag is lined and fitted inside the bucket. However, tying knots into trash bags in order to secure them to the bucket is an inconvenient and time-consuming process.

Furthermore, after a trash bag is full, the user typical tie the opening of the trash bad into a knot to seal the bag from unpleasant trash odors. This requires additional undertaking by the user, which may be challenging especially when the trash bag is filled with too much trash. Fiddling with the trash bag could result in tears in the bag and spilling of the contents therein.

Recently, some companies offer automated trash can solutions that purported simplifies the process of lining and sealing of trash bags in trash cans. For example, CN108163409A filled by Xiaomi discloses the concept of a trash can which seals a trash bag from and cutting the trash bag from the liner supply using a cutter upon tilting the bucket of the trash can. Various US patent applications filed by Shanghai Townew discloses concepts of smart trash receptacles with various features and functions, e.g., US20190382198A1, US20190382197A1, US20190382196A1, U.S. Ser. No. 10/889,432B2, U.S. Ser. No. 10/865,041B2, etc. They are directed to trash receptacles that require a complex sealing and cutting actuator mechanism that moves in X-Y directions in a plane.

While these trash receptacles purportedly include improved functions and features, however, none of the earlier disclosed trash receptacle concepts are reduced to practical commercial embodiments.

Therefore, it is desirable to simplify the process of lining and fitting of disposable trash bags inside a trash can and to further simplify the sealing of the trash bags after filling with trash and relining of the trash can with a fresh trash bag. There remains a need for a new and improved design for a smart trash can to overcome the problems stated above.

### SUMMARY OF THE INVENTION

In one aspect, the present invention is directed to a smart trash can, comprising a housing comprising a housing base, a housing back at a rear of the housing, a housing door at a front of the housing, a housing wall at each of left and right sides of the housing, and a crown of the housing having a lid, wherein the housing base, the housing back, the housing door, the housing walls, and the crown define an interior of the housing. The bottom edge of the front housing door is pivotally support on the housing base and configured to be pivotable to tilt with respect to the housing base and away from the housing back to a tilted open position. A bucket is received in the interior of the housing, wherein the bucket has an opened interior space defined by a front side attached to or that is an integral part of the housing door (i.e., the housing door and the front side of the bucket may be essentially a same structure with an exterior aesthetically finished panel), a rear side, two lateral sides and a bottom. The bucket is tilted along with tilting of the housing door, wherein the housing door in the tilted open position allows user access to the interior of the bucket.

A trash bag liner cartridge is installed/supported below the lid within the crown of the housing, wherein the liner cartridge comprises an annular cartridge housing defining an internal annular space and a central opening at a center of the annular cartridge housing. The annular space stores a supply of a continuous tubular length of plastic liner material (e.g., accordion-folded therein) to be used to line the interior walls of the bucket to form trash bags, wherein the plastic liner material extends from the annular space through the central opening of the liner cartridge to depend below the liner cartridge to line the interior space of the bucket. A depending bottom end of the liner material is sealed, thereby defining a trash bag extending to the bottom, lining the interior of the bucket and having an opening below the central opening of the liner cartridge for receiving trash.

The smart trash can includes a trash bag sealing and cutting mechanism that is configured to seal a top opening of a filled trash bag in the bucket and separate the liner material supplied and extending from the liner cartridge upon tilting the housing door to the tilted open position, and to seal an open bottom end of the liner material supplied and extending from the liner cartridge to prepare for a next (i.e., a fresh) trash bag. A bag relining mechanism configured to line the interior walls of the bucket with the liner material having the sealed bottom end to form a fresh trash bag, wherein the filled trash bag is replaced by the fresh trash bag upon removal of the filled trash bag from the bucket and closure of the housing door from its tilted open position. The lining of the bucket with an initial trash bag can be automatically performed as discussed below with respect to the “fresh trash bag”.

In one embodiment, the trash bag sealing and cutting mechanism comprises a heating module at the crown above a top edge of the housing door; a backing block provided at a top edge of the rear side of the bucket. Upon tilting of the housing door and the bucket, the backing block at the top of the rear side of the bucket is moved towards the heating module at the crown, to thereby press two layers of the liner material extended between the heating module and the backing block. The heating module seals the top opening of the filled trash bag in the bucket and separate the liner material supplied and extending from the liner cartridge upon tilting the housing door to the tilted open position, and to seal the open bottom end of the liner material supplied and extending from the liner cartridge to prepare for a next (i.e., a fresh) trash bag.

In one embodiment, after the trash bag in the bucket is filled with trash to a desired level/capacity, with the front housing door in the tilted open position to press the liner material between the heating module and the backing block, heat is applied by the heating module to soften/slightly melt the plastic liner material to seal the opening of the filled trash bag in the bucket, to seal a strip of fresh plastic liner material extending from the liner cartridge which is above the opening (i.e., a sealed opening) of the filled trash bag to form a sealed bottom end of a fresh trash bag (i.e., another, next, new trash bag) to be lined in the interior of the bucket, and to melt (which may be to an extent to cut) the plastic material between the sealed bottom end of the fresh trash bag and the sealed opening of the filled trash bag in the bucket to facilitate separating the filled trash bag from the sealed bottom end of the fresh trash bag. The housing door in the tilted open position allows user access to remove the filled trash bag in the bucket.

In one embodiment, the heating module comprises at least three longitudinal heating wires spanning/extending along the width of the trash can, with enough length to cover the width of the trash bag liner from the liner cartridge. The heating wires are arranged in parallel, with the upper wire used to heat locally to seal the liner material supplied from the liner cartridge to form the sealed bottom end of the new/fresh trash bag (i.e., the next trash bag to be deployed automatically into the bucket), the middle wire is used to heat melt the liner material locally to separate/cut the liner material, and the lower wire is used to heat seal the liner material locally at the top open end/edge of the filled trash bag present in the bucket.

In one embodiment, the heating/sealing operation is coordinated with the tilting of the front housing door. In particular, the heating/sealing operation is performed on the plastic liner material when the front door of the trash can along with the bucket is tilted forward to the tilted open position, and upon reaching the fully opened position, the heating module and the backing block are pressed together with two layers of plastic liner material therebetween. The heating wires are turned on in sequence, comprising: (a) after the heating module is pressed onto the two layers of plastic material against the backing block, the upper heating wire is turned on for a duration and at a temperature sufficient to melt/soften locally the two layers of plastic liner material designed to be used with the trash can, to the extent that the melted/softened location of the plastic material will solidify after heat is removed, so as to seal the two layers of plastic material together; (b) the lower heating wire is then turned on for a duration and at a temperature sufficient to melt/soften locally the two layers of plastic liner material to result in a seal when heat is removed; and (c) the middle heating wire is then turned on for a duration, long enough at a particular temperature to heat locally to completely melt the two layers of plastic material thereby severing/cutting/separating the portions of the plastic material at both sides of this middle heating element/wire, thereby to separate the sealed trash bag from the liner material supplied from the liner cartridge. The filled plastic bag in the bucket is thereby sealed at the top by the lower heating element, and the supply of plastic liner material from the liner cartridge is sealed by the upper heating element to form a sealed bottom end of the fresh plastic bag to be lined/fitted into the bucket after the filled/sealed trash bag has been removed, with the sealed bottom end of the fresh plastic bag separated from the top of the trash bag in the bucket, thereby completing a cycle of the sealing and cutting operation/procedure, with the tilting opening of the bucket, and leaving the bucket opened for the user to conveniently remove the sealed trash bag.

In one embodiment, the filled trash bag in the bucket is automatically replaced by the fresh trash bag upon removal of the filled trash bag from the bucket and closure of the housing door from its tilted open position.

In one embodiment, the trash bag relining mechanism comprises at least a vent opening near a bottom of the bucket; a suction/exhaust fan (attached to the outside of the bucket or on the housing base) configured to exhaust air from the interior of the bucket via the vent when the housing door is in the closed position. When the liner cartridge is initially supported in the crown of the housing, with the housing door closed, the suction fan exhausts air from the bucket to thereby pull the sealed bottom end of the liner material towards the bottom of the bucket, to thereby line the interior of the bucket to form the trash bag having an opening for receiving trash (i.e., the first trash bag after placement of the liner cartridge in the trash can housing crown section). After the filled trash bag is filled, sealed and removed from the bucket, and the housing door closed from its tilted open position, the suction fan exhausts air from the bucket to thereby pull the sealed bottom end of the liner material towards the bottom of the bucket, to thereby line the interior of the bucket to form the fresh trash bag having an opening for receiving trash, whereby the fresh trash bag replaces the filled trash bag in the bucket.

In one embodiment, the smart trash can further comprising sensors for various monitoring functions, including: user interaction with device, monitoring level/capacity of trash in the trash bag, sensing location and/or presence of plastic liner material at the bottom of the bucket, and confirming opening and closure of housing door and lid.

In one embodiment, the smart trash can further comprises a tilting mechanism which may comprising a rack and pinion gear assembly (e.g., having a slidable track/rail and pinion gear module) to tilt the housing door and bucket, and a drive motor and gear module for flipping over the lid.

In one embodiment, the smart trash can further comprises a control module controlling the various operations of the trash can in response to a user action (e.g., automatically as programmed based on user requests and/or actions).

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals/designations designate like or similar parts throughout the drawings.

FIG. 1 is a picture of a smart trash can with motion sensor being activated by a user, in accordance with one embodiment of the present invention.

FIGS. 2A to 21 are perspective views various configurations of a smart trash can, in accordance with one embodiment of the present invention, with: lid closed; lid open showing trash bag liner cartridge installed in the crown section of the housing, with liner material extending into the bucket in the housing; close-up of the liner cartridge in the crown section; front housing door in tilted open position sealing the trash bag in the bucket; close-up of the crown section with the front housing door in the tilted open position; lid open without the liner cartridge installed (2 views); lid open and front housing door in fully tilted open position without the liner cartridge installed, showing the bucket attached to and tilted with housing door; lid open and front housing door in partially tilted open position without the liner cartridge installed, showing the presence of the backing block at the top rear edge of the bucket. FIG. 2J is a sectional view with the lid closed and front housing door closed.

FIG. 3A is a perspective view of the trash bag liner cartridge with liner material having a sealed bottom end depending from the central opening, extending from a gap CG under the cover CL, and FIG. 3B is a perspective view of the trash bag liner cartridge without its cover, showing the supply of liner material stored in the annular space of the liner cartridge, in accordance with one embodiment of the present invention.

FIG. 4A is a perspective view of the housing of the trash bag liner cartridge with cover, and FIG. 4B is a perspective view of the housing of the trash bag liner cartridge without its cover, in accordance with one embodiment of the present invention.

FIG. 5A is a perspective sectional view showing the underside of the crown section of the trash can housing, in accordance with one embodiment of the present invention; FIG. 5B is a close-up perspective view of the trash level overflow/overfill sensor; FIG. 5C is a perspective view of the trash level overflow/overfill sensor.

FIGS. 6A to 6C are respective perspective views of: the interior of the trash can with the lid flipped open; the drive motor for the lid flipping mechanism; the gear module for the lid flipping mechanism; in accordance with one embodiment of the present invention.

FIGS. 7A to 7D are various perspective views showing the vents in the bucket for the trash bag lining mechanism, including vents in the bucket and exhaust ports at the housing base, and sensors for monitoring the presence of trash bag/liner materials in accordance with one embodiment of the present invention.

FIG. 8A is a perspective sectional view showing the bucket being an integral part of the housing door and being tilted with the housing door in the fully titled open position and the heating module pressed towards the backing block (without the trash bag liner shown); FIG. 8B is another perspective view showing the bucket without the exterior aesthetic housing door panel attached thereto, in accordance with one embodiment of the present invention.

FIG. 9A is a perspective sectional view showing the embodiment of the backing block attached to the top of the rear side of the bucket and the heating module at the crown section of the bucket; FIG. 9B is a perspective sectional view showing the alternate embodiment of the heating module attached to the top of the rear side of the bucket and the backing block at the crown section of the bucket.

FIG. 10A is a perspective view showing the tilting mechanism with the bucket/housing door in fully closed position; FIG. 10B is a perspective view showing the tilting mechanism with the bucket/housing door tilting from the closed position to the fully tilted open position, in accordance with one embodiment of the present invention.

FIGS. 11A to 11E are perspective views of the tilting mechanisms and its components, in accordance with one embodiment of the present invention.

FIGS. 12A to 12E are perspective views illustrating the placement of sensors at the edge of the housing door for anti-jamming safety, and/or to determine closure status of the housing door in the fully closed position.

### DESCRIPTION OF ILLUSTRATED EMBODIMENTS

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In one aspect of the present invention, it simplifies the relining of disposable trash bags inside a trash can and to further simplify the sealing of the trash bags after filling with trash and relining of the trash can with a fresh trash bag, without any touching of the trash bags by the user. The improved design and configuration of the smart trash can in accordance with the present invention overcomes the problems in the prior art by automating the lining and fitting of a fresh trash bag inside the trash can, sealing a filled trash bag, and relining and fitting of a fresh trash bag after the sealed trash bag has been removed by the user, without any touching of the trash bags by the user. Consequently, the user does not need to manually line trash bags inside the trash can, does not need to manually seal filled trash bags, and does not need to manually reline trash bags after filled/full trash bags are removed. The user only needs to remove and dispose of the sealed filled trash bags and thereafter a new plastic bag will be automatically lined and fitted in the inside bin/bucket ready for trash collection.

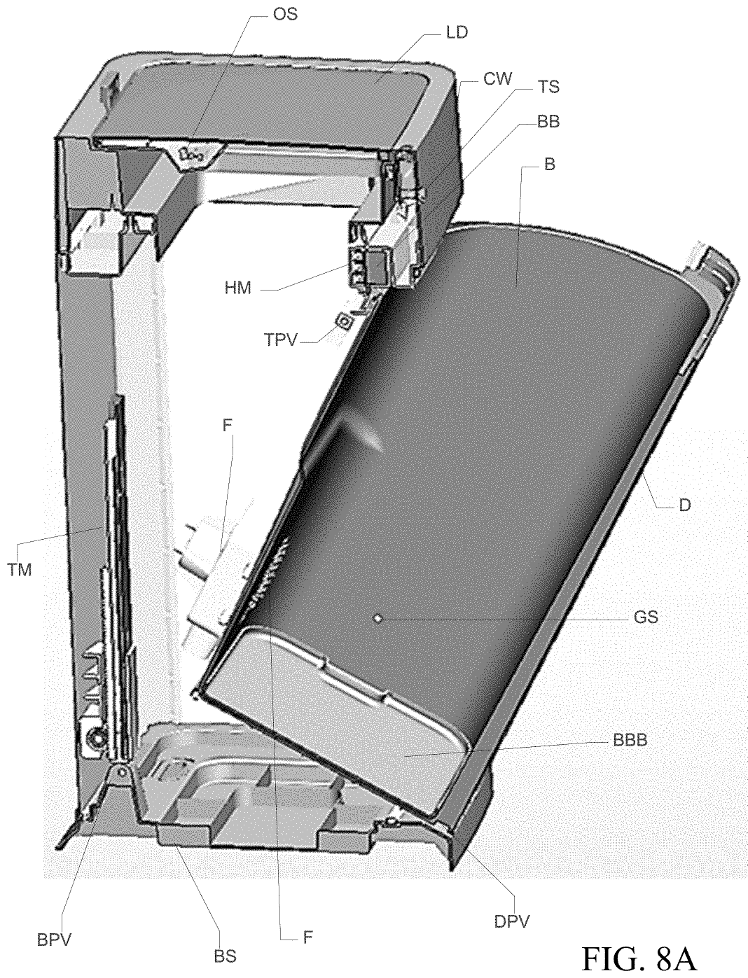

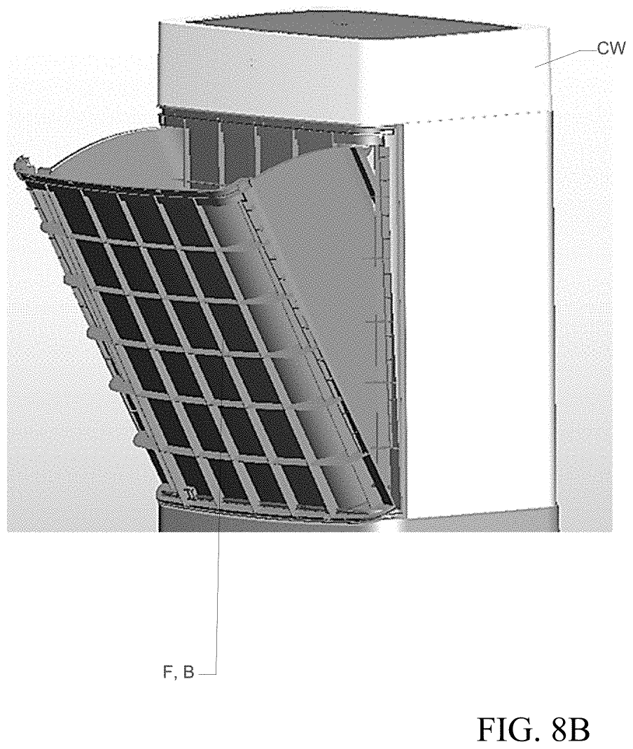

Referring to the embodiments of the present invention depicted in the drawings, the inventive smart trash can T (e.g., for kitchen use) has a housing H, which may include a metal (e.g., stainless steel) aesthetic skin/panel over an internal hard plastic frame (see FIG. 8B without the external panel). The trash can T includes a lid L at the top which flips open to allow access into the trash can T, and a door D in the front which is pivotally support at DPV by the trash can base BS to tilt to open to provide access for removable of a filled trash bag G. Inside the trash can housing H, a hard liner/bin/bucket B is attached to or an integral part of the front door D so that it can tilt along with the tilting opening of the front door D. As shown in FIG. 8B, the bucket B is shown without the exterior panel of the front housing door D. The bucket B could be removably attached to the back of the front door D, or the front door D could be made part of the tiltable bucket B (i.e., the front door D is the front wall or façade of the bucket B). As will be explained in greater detail below, the tilting of the bucket B to the opened position results in sealing of the trash bag G held in the bucket B, and cutting of the sealed trash bag G to separate from the supply of liner material M from the liner cartridge C, all in a substantially single actuated tilting motion of the bucket B. As shown in the drawings, the bucket B includes a bottom BBB (see, e.g., FIG. 8A).

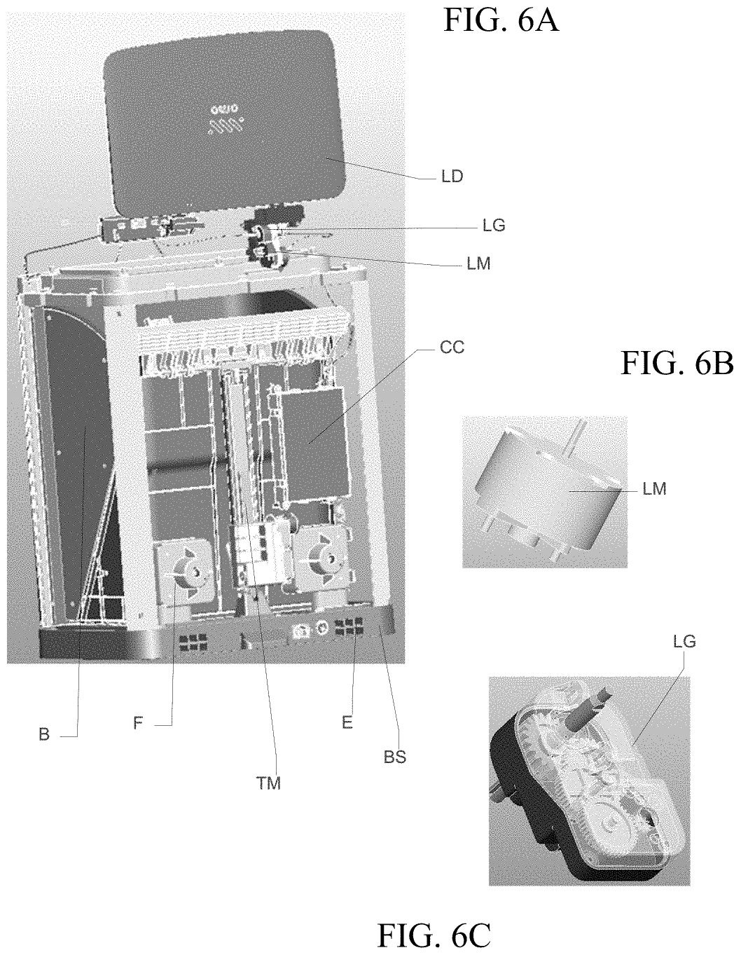

The tilting of the front door D and the flipping of the lid LD are driven automatically by drive motors LM and gears LG (see, FIGS. 6A to 6C), in response to user instructions via sensors, a remote control, or an app on a mobile device. The particular driving mechanisms for the front door D and the lid LD may adopt known electro-mechanical driving mechanisms (e.g., stepper motors and gears) in the prior art, or in accordance with the illustrated embodiments further discussed below. Referring to the embodiment depicted in the drawings (FIGS. 6A to 6C), the lid LD may be driven to flip between an opened position and a closed position by a lid flipping drive mechanism that includes a set of reduction gears LG in a module coupled to a drive motor LM.

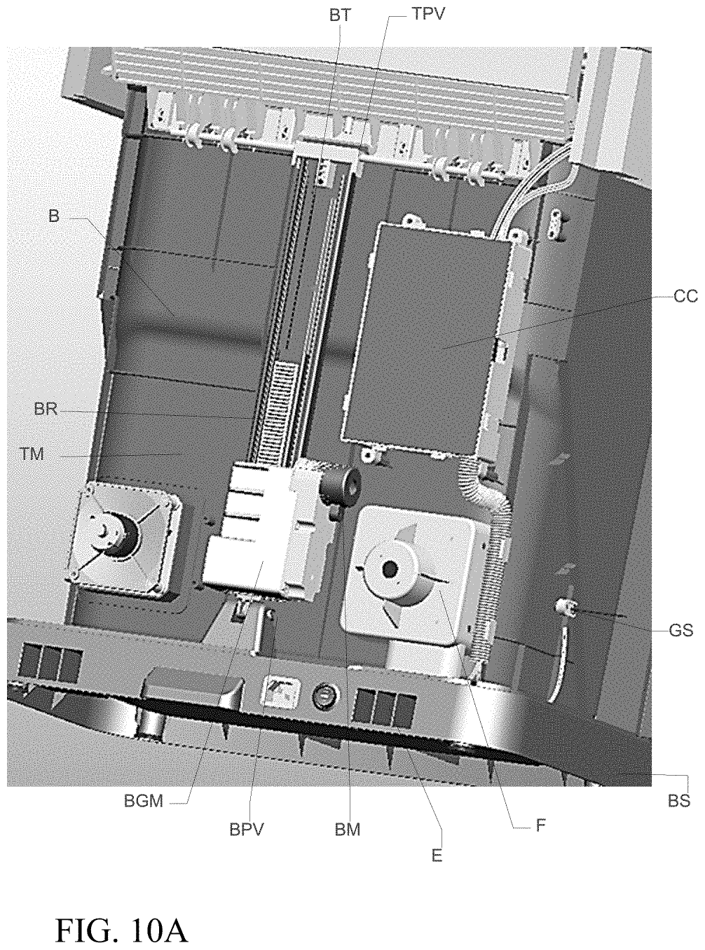

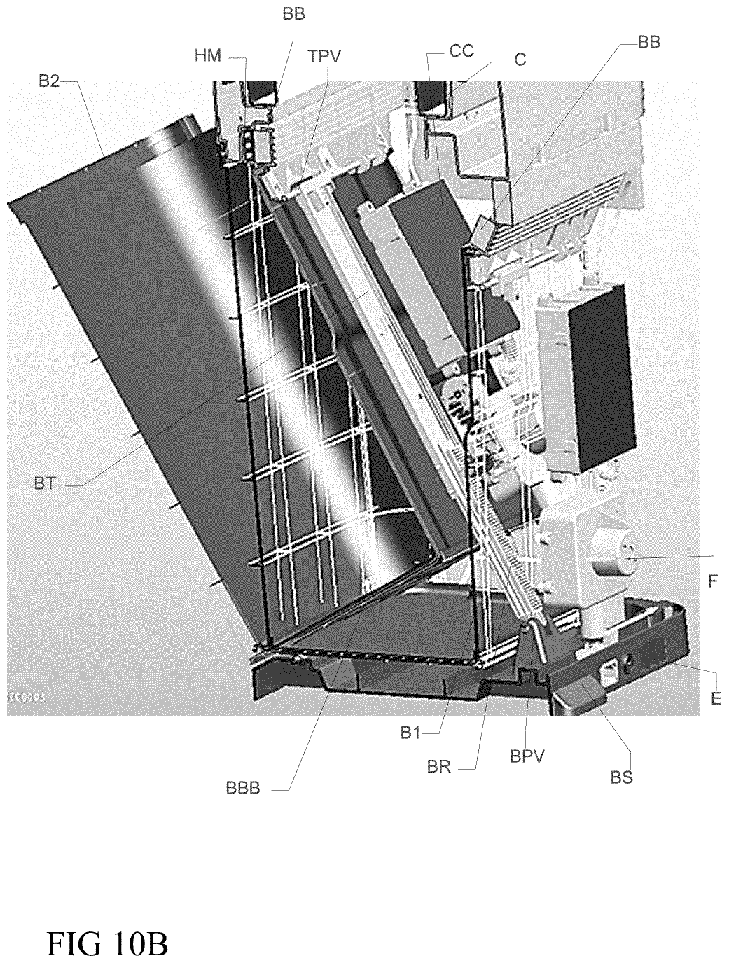

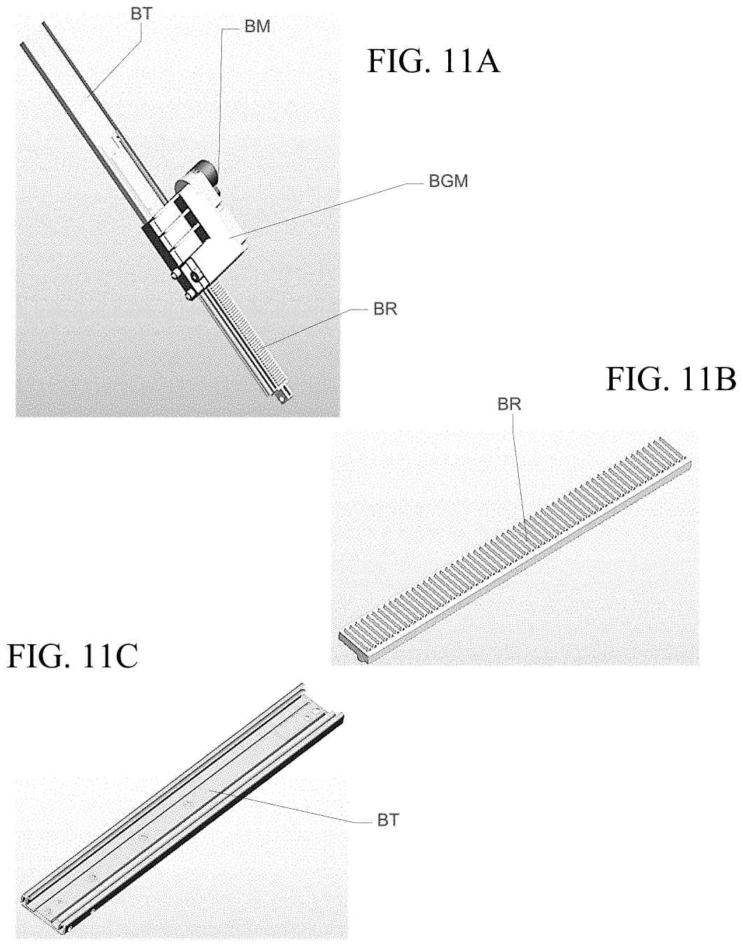

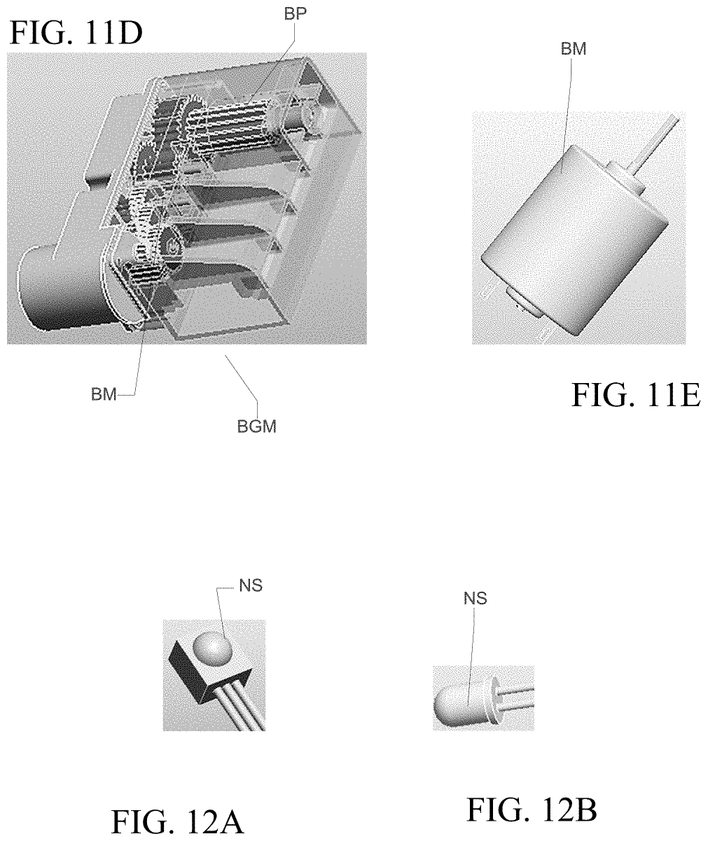

Referring to the embodiment depicted in the drawings (FIGS. 10A and 10B), the bucket B/front door D tilting mechanism TM is implemented with an electric motor BM and a rack and pinion gear assembly. In the illustrated embodiment, the rack BR has a bottom end pivotably coupled to a bottom pivot joint BPV at or near the rear of the base BS of the trash can T and is slidably attached to a linear rail/track BT (e.g., with the rack BR attached to a sliding mount that slides within the rail of the track BT) so that the rack BR can slide longitudinally relative to the track BT. The track BT has an extended top end pivotally coupled to a top pivot joint TPV at or near the rear top edge of the bucket B. FIG. 10B illustrates the movement of the bucket B from the closed position B1 to the fully tilted open position B2.

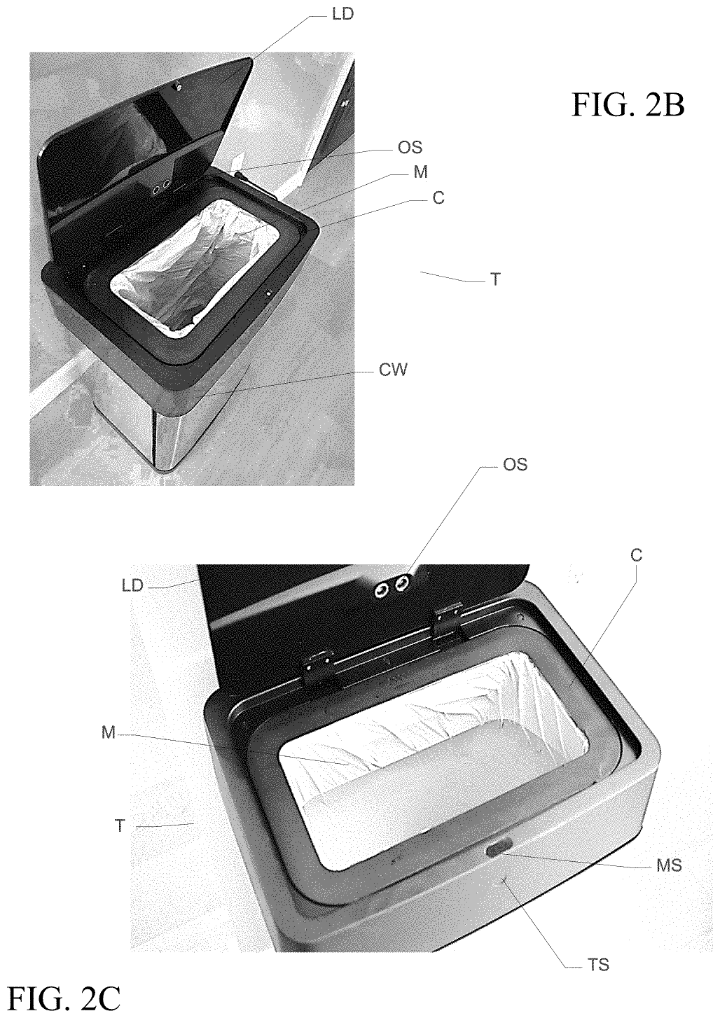

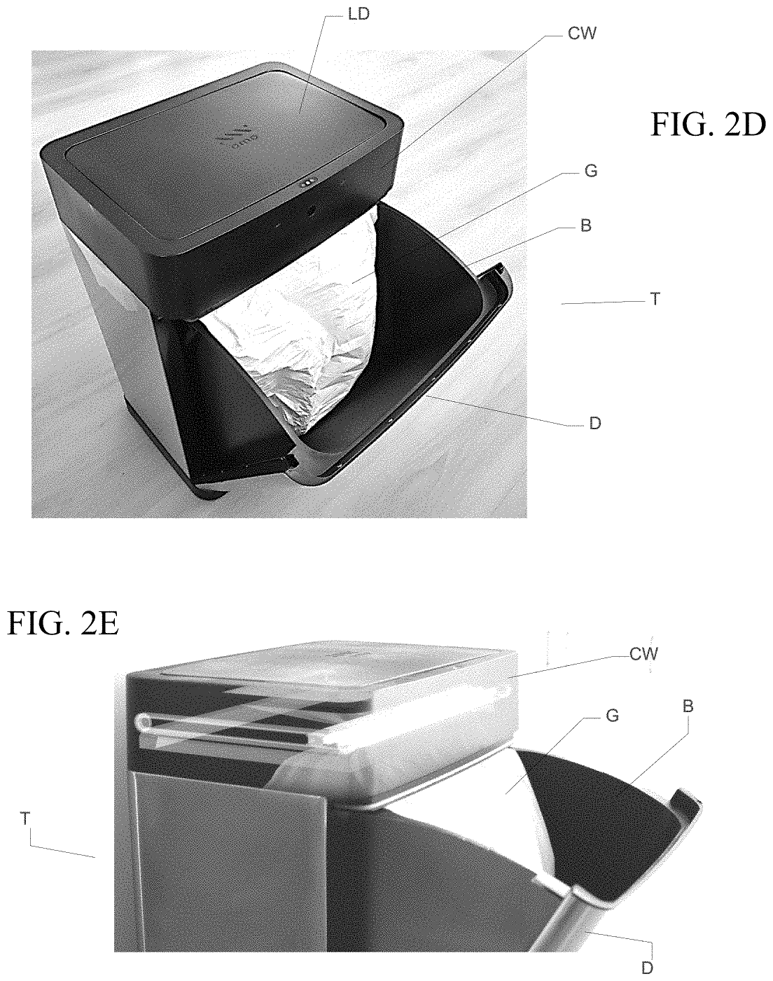

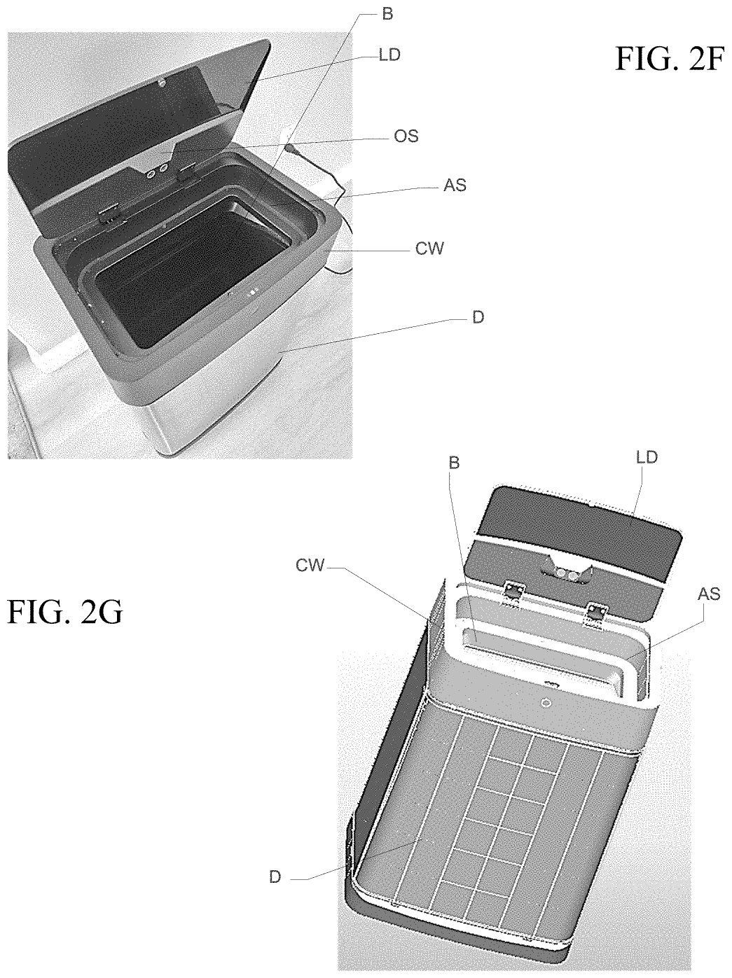

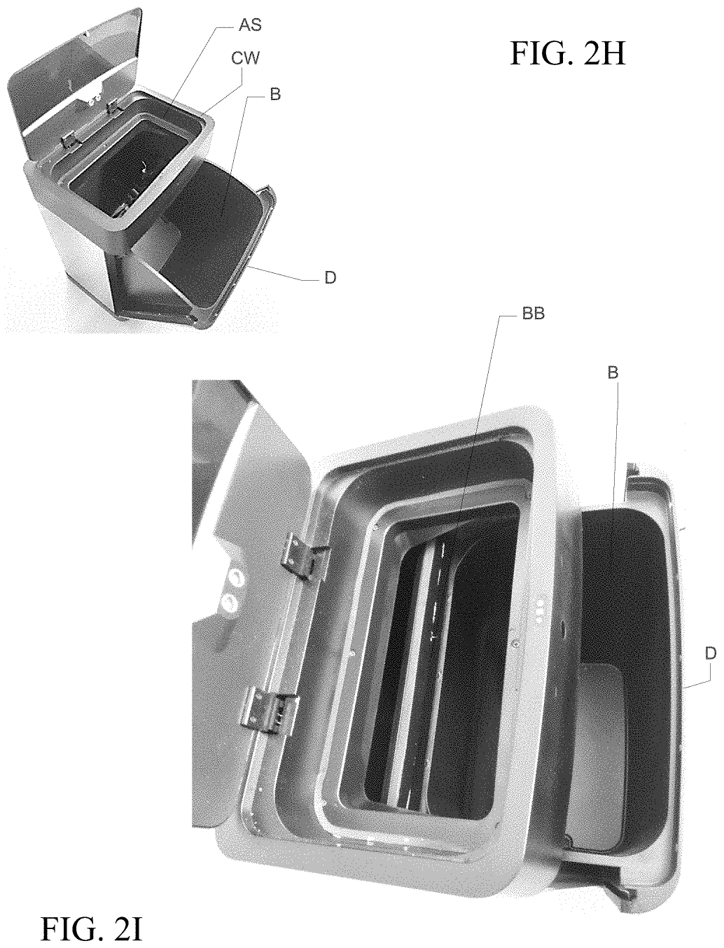

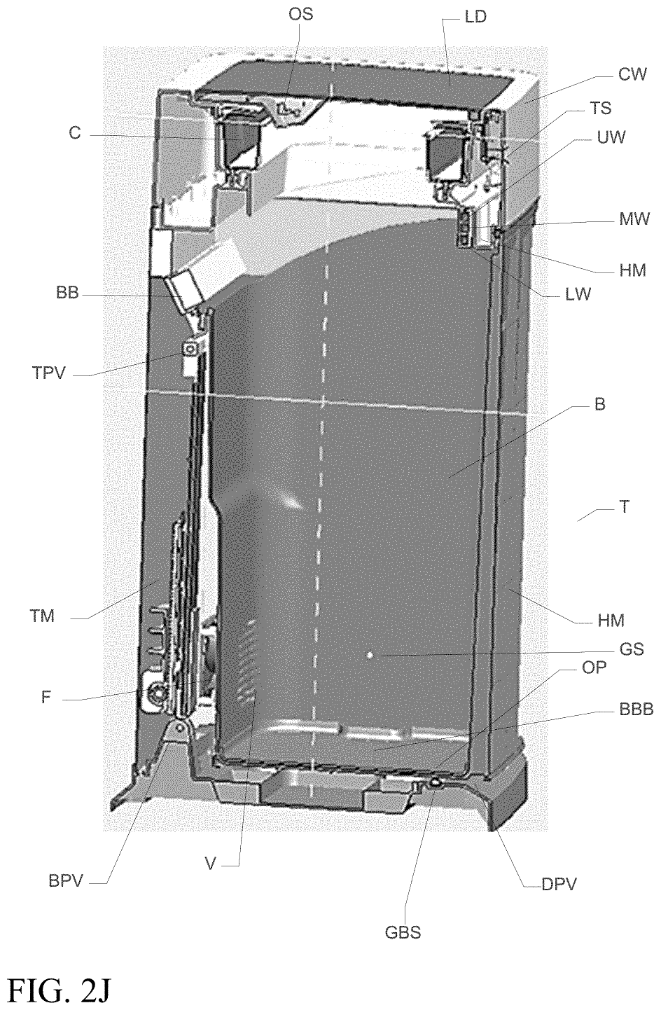

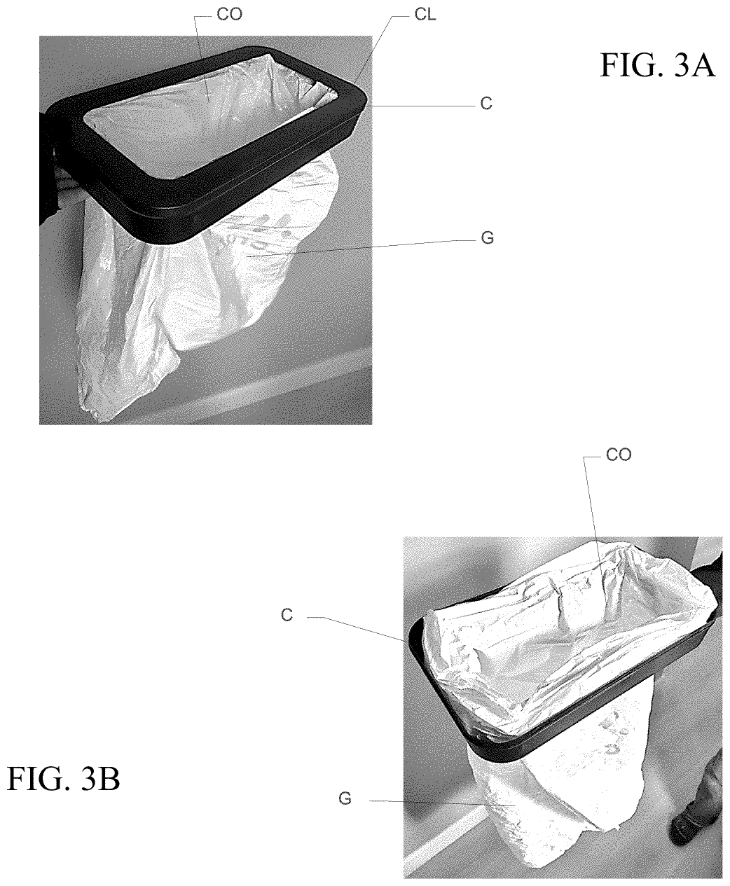

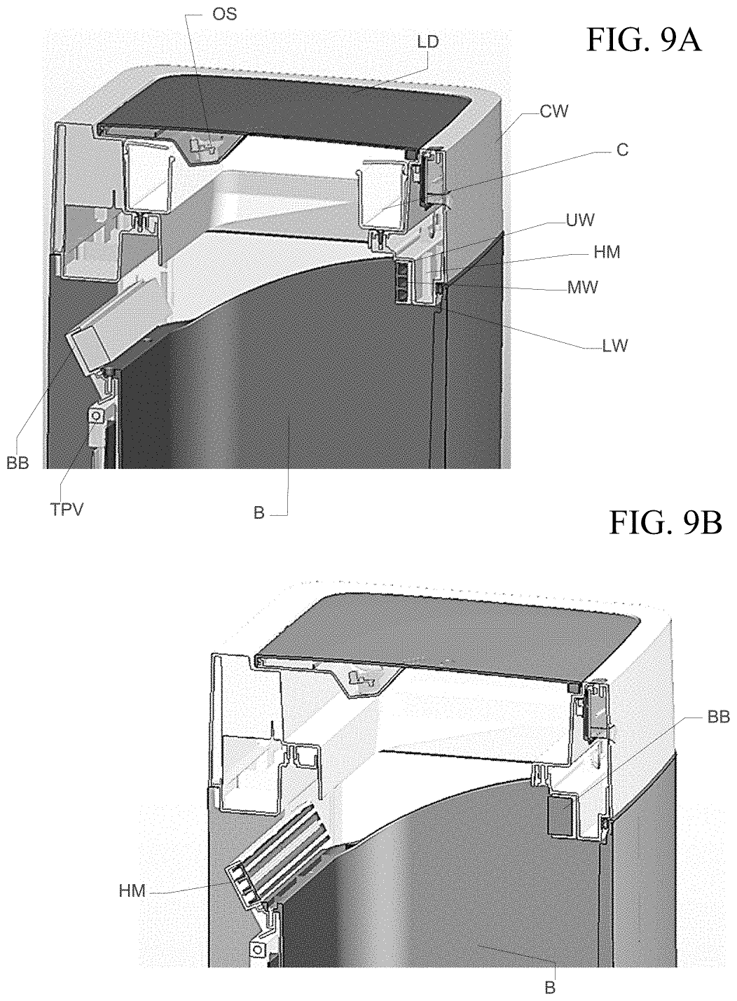

When driven by the motor BM, the pinion BP rotates, thereby extending or retracting the rack BR in relation to the track BT, depending on the rotation of the pinion BP. As the rack BR extends in relation to the track BT, the overall combined length of the rack BR and track BT between the top pivot joint TPV and the bottom pivot joint BPV increases, thereby tilting the bucket B along with the front door D forward towards a tilted opened position. FIGS. 8A and 10B are views illustrating tilting of the bucket B forward from a closed position to an opened position. (It is noted that in FIG. 8A, the tilting mechanism TM is shown with the track BT disconnected from the top pivot joint TPV. It is further noted that in FIG. 8A, as compared to FIGS. 2J and 9A, the heating module HM and the backing block are switched to illustrate an alternate embodiment.) As the rack BR retracts in relation to the track BT, the overall combined length of the rack BR and track BT between the top pivot joint TPV and the bottom pivot joint BPV decreases, thereby tilting the bucket B along with the front door D rearwards towards a closed position (see, FIG. 10A). The rack and pinion gear assembly could include additional reduction gears in a pinion gear module BGM that the drive motor BM is coupled. Alternatively, other types of mechanism could be implemented to tilt the bucket B, such as a hydraulic piston actuator, a magnetic linear actuator, a screw drive actuator, a linear bearing actuator, a linkage rod actuator, a cam actuator, a spring actuator, an electromechanical extending actuator, a rotating actuator, etc., or a combination of two of more of such.

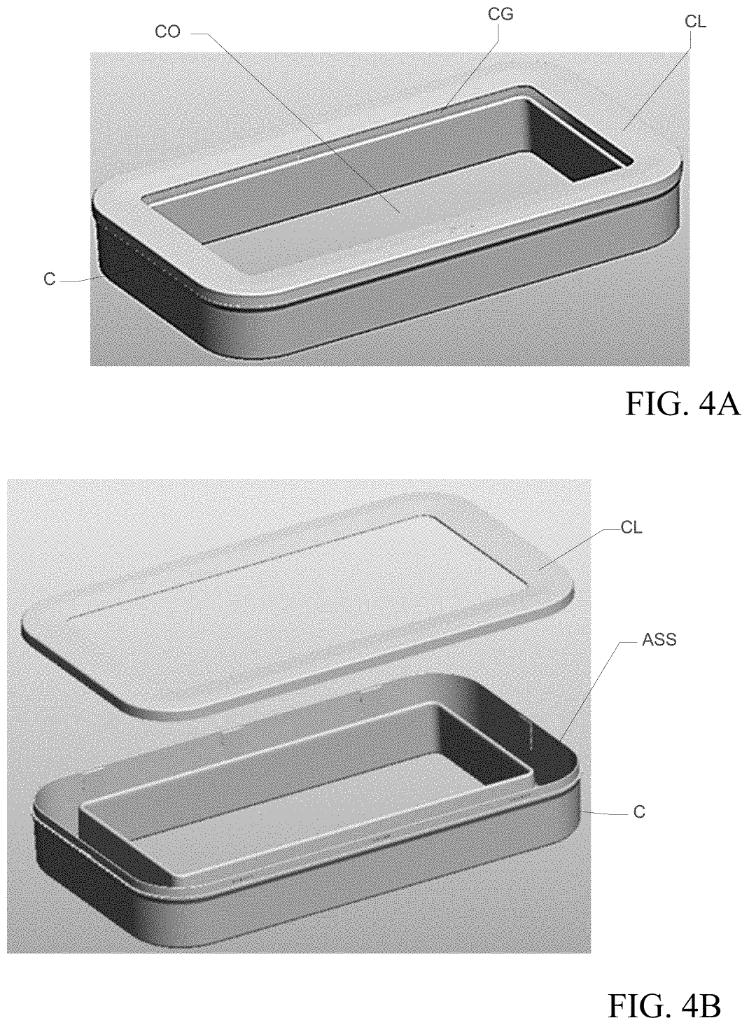

Inside the trash can T, a removable annular (donut) shaped liner cartridge C supplying a plastic liner material M for forming disposable trash bags G is received and supported by the frame of the housing H at the crown section CW, e.g., in an annular groove/slot AS provided in the housing H frame below the lid LD at the crown CW portion of the housing H, above the opening of the bucket B. FIG. 4A is a perspective view of the housing of the trash bag liner cartridge C with cover CL, and FIG. 4B is a perspective view of the housing of the trash bag liner cartridge C without its cover CL, in accordance with one embodiment of the present invention. A gap CG between the cover CL and the housing provides a clearance to allow the liner material stored in the cartridge C to extend from the annular space ASS in the cartridge C.

The cartridge C contains a continuous length of plastic liner material M in tubular or cylindrical structure, having a closed end (which correspond to the bottom of a plastic bag G for initial deployment) at the central opening CO in the annular shaped cartridge C initially prior to start of deployment of the liner material M into the trash can T. As will be explained below, this cartridge C supplies the liner material M through a gap CG (FIG. 4A) into the central opening CO that will form the disposable plastic bags for lining and fitting in the bucket B of the trash can T. The continuous tubular length of plastic material M could be folded in an accordion manner in the annular spacing ASS of the liner cartridge C, which can be dispensed in a continuous fashion by extending from the accordion folds to inside the interior of the bucket B (further details to be discussed below). The liner cartridge C is disposable after all liner material M has been used and replaced with a fresh liner cartridge C. The user can conveniently and easily replace the spent liner cartridge C by dropping a new liner cartridge C into the cartridge support (e.g., an annular groove/slot AS) at the top of the trash can T.

The following are examples of alerts and safety functions/features of the trash can T:
LED/sounds will alert the user if the trash bag G is not completely removed.
Automatically reopens the trash can front door D if movement is detected (by a hand or objects) inside the trash can front door D closing area.
Will not perform the sealing process if the trash can T does not detect a trash bag G inside.
If there is a loss of power during the sealing process, the trash bag G will stop the sealing process. Once power is restored, it will recheck for a bag G then restart the sealing process.
The trash can front door D will not close if the full trash bag G is not removed after the sealing process.

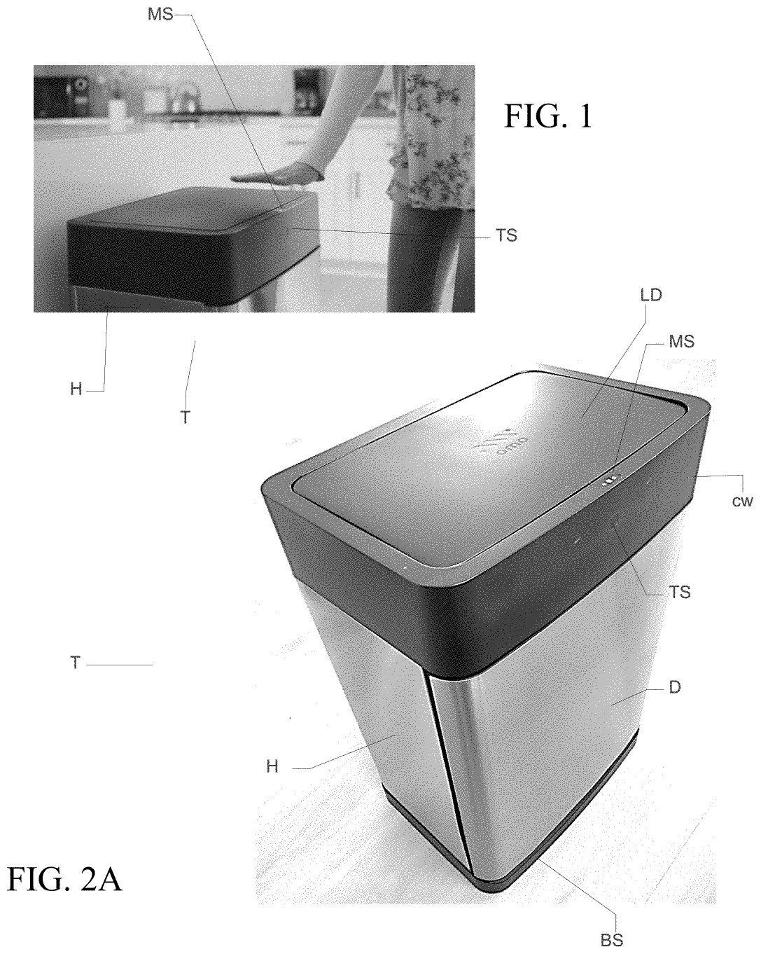

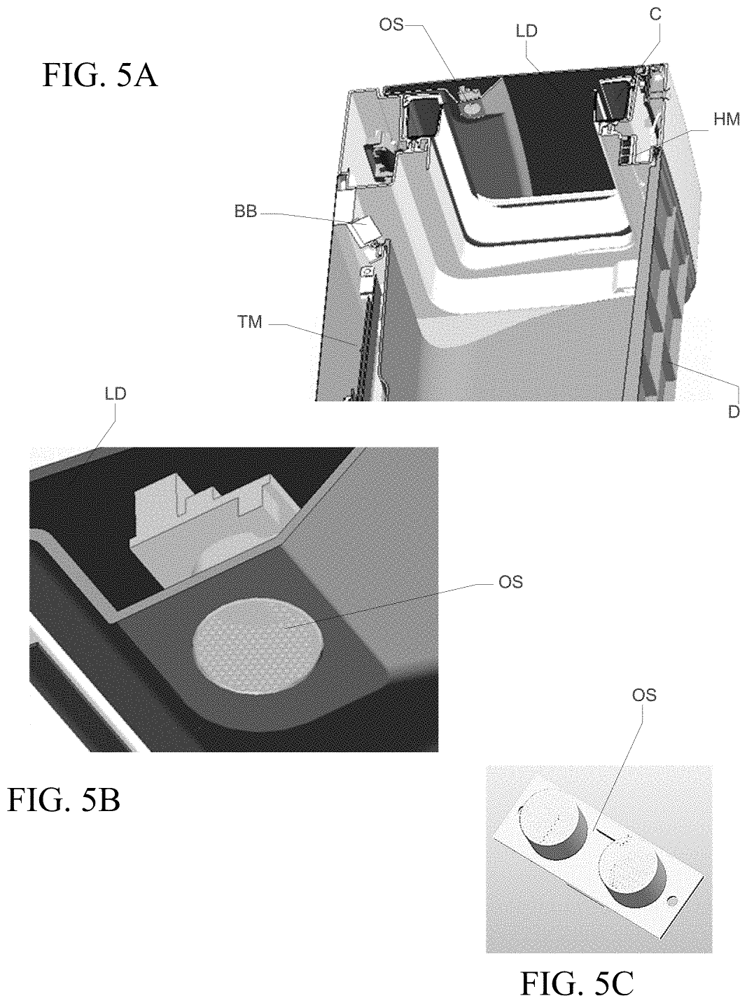

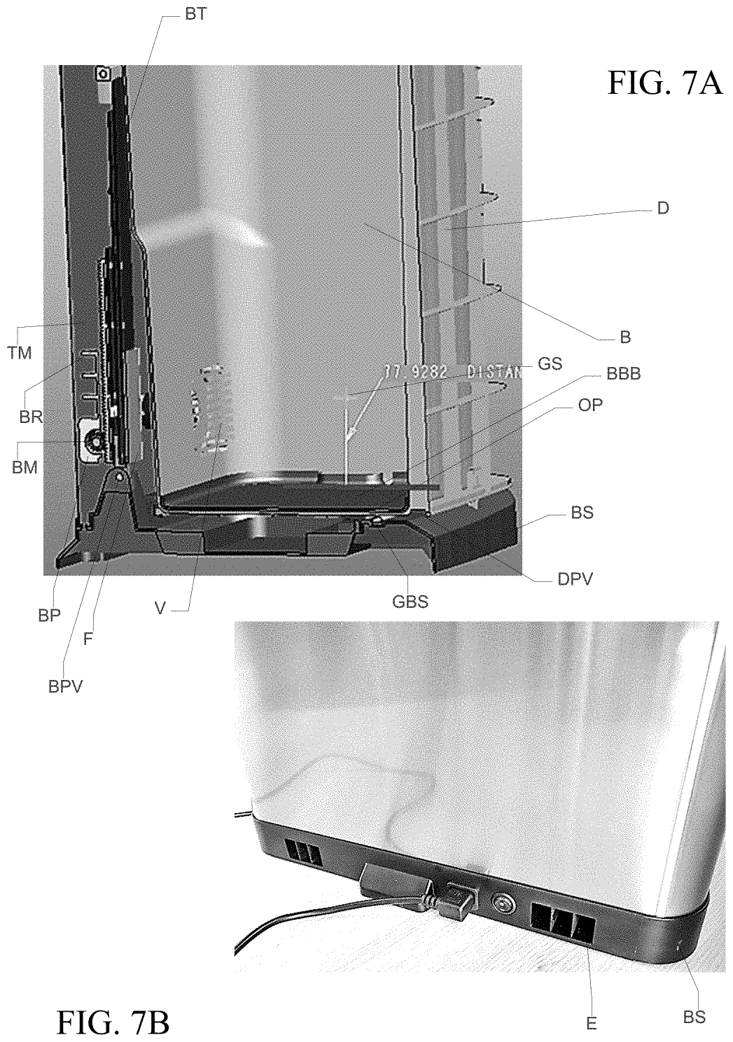

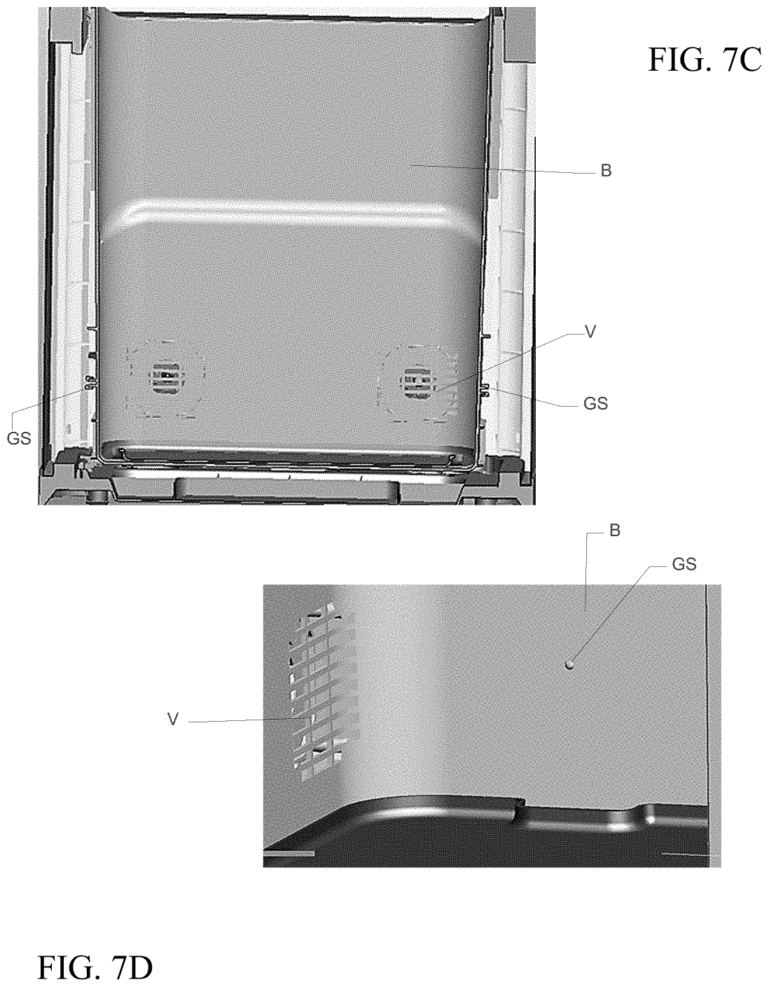

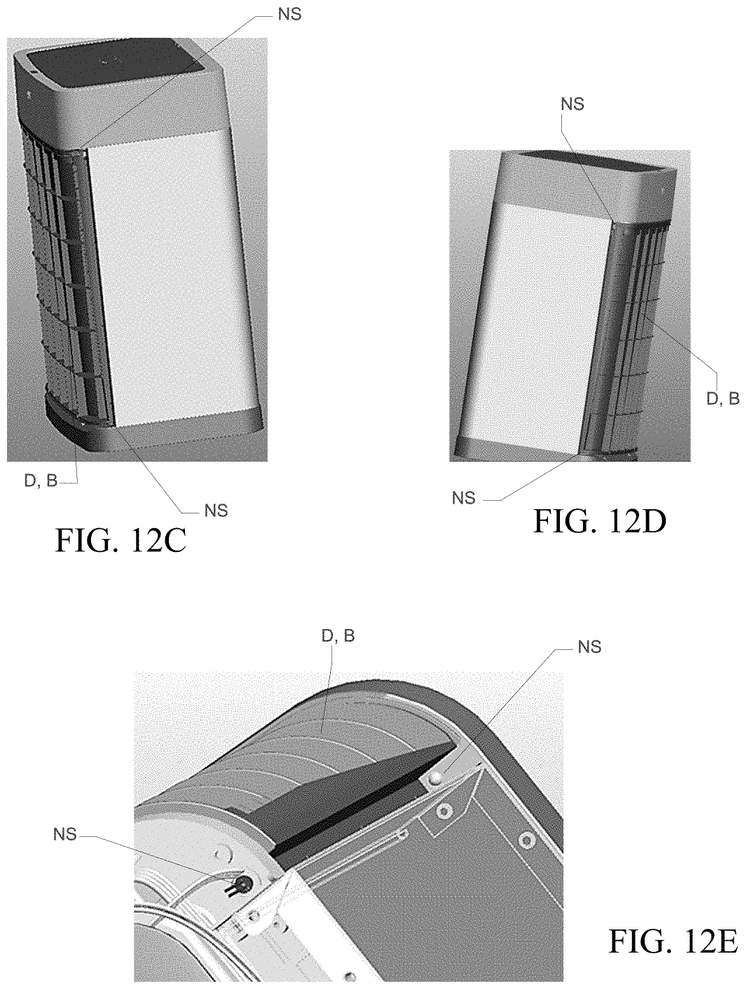

Various sensors are provided in the trash can T to implement the above, which may include: one or more touch sensors TS (see, e.g., FIGS. 1 and 2A) for user operation to open/close the lid LD to toss trash into the trash can T and/or opening the front door D to remove a sealed trash bag G, and/or activating the trash can T to initiate and undertake trash bag sealing; a motion sensor MS (see, e.g., FIGS. 1 and 2A) to detect proximity of a part of user body to open/close the lid LD automatically to provide user access; a plurality of sensors to facilitate and/or ensure safe operation of the moving components of the trash can T, including anti-nipping sensors NS (e.g., infrared sensors; see, e.g., FIG. 12A to 12E)) on the side of the housing H to prevent nipping of user fingers by a closing door D, a bag deployment sensor GS (e.g., infrared sensors; see, e.g., FIGS. 7A and 7D) detecting the fitting of a plastic trash bag G inside the bucket B, an overflow/overfill sensor OS (e.g., an ultrasound distance sensor; see, e.g., FIGS. 2F, 2G, 5A to 5C) at the bottom of the lid LD to detect the level of filling of the trash bag G to determine if the designed filling capacity/level has been reached to prevent overfill of the trash bag G that could affect subsequent closure of the trash bag G in subsequent heat sealing/cutting operations.

The interior bucket B is vented near the bottom by one or more exhaust/suction fans F. One or more air vents V are provided at the base BS of the housing H. A wall spacer extends from the base BS of the trash can T to ensure a sufficient spacing between the rear of the trash can T and an adjacent structure (e.g., a wall or cabinet) to allow air in the bucket B to be sucked and vented from the bucket B to the exterior through exhaust ports E provided at the housing base BS. In operation, the exhaust fans F operate to draw down air pressure inside the bucket B, thereby pulling the sealed end of the plastic liner material M from the cartridge C into the bucket B and against the inner walls of the bucket B. The drawn air is pushed by the suction/exhaust fan F to outside of the housing H via the exhaust ports E at the base BS. In the illustrated embodiment, the exhaust fans F are attached to the bucket B at the vent V locations, hence the exhaust fans F move along with tilting motions of the bucket B. The air suction operation creates a negative pressure to pull on the liner material M supplied from the liner cartridge C, and the negative pressure lines and fits the plastic liner material M to conform generally to the interior of the bucket B, thus forming a plastic trash bag G for collecting trash tossed into the bag G. The bag deployment sensor is provided near the bottom BBB of the bucket B, e.g., at about 7 to 8 cm from the bottom. It detects the position of the plastic trash bag G as it reaches the bottom of the bucket B. It also detects whether a full and sealed trash bag G has been removed from the bucket B to begin the next cycle of lining and fitting a replacement trash bag G in the bucket B. More specifically, when a new cycle of lining and fitting a replacement trash bag G is initiated, the suction fans pulls the plastic liner material M into the bucket B. As the liner material M reaches the bottom of the bucket B and triggers the IR sensor, the suction fans will stop after a short period (e.g., 2 seconds) to allow the bag G to fully reach and fit to the inside bottom of the bucket B. See, generally, FIGS. 2B and 2C. In addition, a further sensor GBS may be provided at the base BS of the housing H to detect the presence of the bottom of the bag G through a small opening OP in the bottom BBB of the bucket B (see, FIGS. 2J and 7A). The heat sealing/cutting procedure is prevented from operating if a plastic bag G is not detected inside bucket B of the trash can T.

Referring to FIGS. 2J, 8A, 9A and 9B), the inside front edge of the housing H (at the crown section CW) and the rear edge of the opening of the bucket B are provided with complementary sealing/cutting assembly structures to facilitate sealing and cutting of plastic bags lined in the bucket B. In one embodiment shown in FIG. 9A, below the liner cartridge C, supported at the inside front edge of the housing H (or a frame thereof) is a longitudinal heating module HM (e.g., comprising heating elements in the form of heating wires), which works in conjunction with a complementary longitudinal strip of heat tolerant backing block BB (e.g., a foam insulated cotton material) supported along the edge at the rear of the bucket opening. In another embodiment shown in FIG. 9B, the locations of heating module HM and the backing block BB are switched or swapped between the bucket B and the front frame of housing H at the crown section CW; the heating module HM is located at the rear of the lip of the bucket opening, and the backing block is located at the front of the frame below the liner cartridge C.

In one embodiment, the heating module HM includes three longitudinal heating elements/wires (UW, MW, LW) spanning/extending along the width of the trash can T, with enough length to cover the width of the trash bag G liner from the liner cartridge C. The heating wires (UW, MW, LW) are arranged in parallel, with the upper wire UW used to heat locally to seal the liner material M supplied from the liner cartridge C to form the bottom of a new trash bag G (i.e., the next trash bag G to be deployed automatically into the bucket B), the middle wire MW is used to heat melt the liner material M locally to separate/cut the liner material M, and the lower wire LW is used to heat seal the liner material M locally at the top edge of the trash bag G present in the bucket B.

In operation, the heating/sealing operation is performed on the plastic liner material M when the front door D of the trash can T along with the bucket B is tilted forward to the opened position. Upon reaching the fully opened position (see, e.g., FIGS. 2D and 9A), the heating module HM and the backing block BB are pressed together with two layers of plastic liner material M therebetween. In this position, the heating wires are turned on in sequence. Specifically, after the heating module HM is pressed onto the two layers of plastic material M against the backing block BB, the upper heating wire UW is turned on for a duration, e.g., for 3.5 seconds, and at a temperature sufficient to melt/soften locally the two layers of plastic liner material M designed to be used with the trash can T, to the extent that the melted/softened location of the plastic material M will solidify after heat is removed, so as to seal the two layers of plastic material M together. The lower heating wire LW is then turned on for a duration, e.g., for 3.5 seconds, and at a temperature sufficient to melt/soften locally the two layers of plastic liner material M to result in a seal when heat is removed, as was in the case of the upper heating wire UW. Next, the middle heating wire MW is then turned on for a duration, e.g., for 18 seconds, long enough at a particular temperature to heat locally to completely melt the two layers of plastic material M thereby severing/cutting/separating the portions of the plastic material M at both sides of this middle heating element/wire, thereby to separate the sealed trash bag G from the liner material M supplied from the liner cartridge C. (In an alternate embodiment, the lower heating wire LW can be turned on first and the upper heating wire UW is then turned on. Alternatively, both the upper heating wire UW and the lower heating wire LW may be turned on at the same time or near the same time without waiting for the other wire to be turned off. Similarly, the middle heating wire may be turned on together with one or both of the upper and lower heating wires or near the same time.) As a result, the plastic bag G in the bucket B is sealed at the top by the lower heating element/wire LW), and the supply of plastic liner material M from the liner cartridge C is sealed by the upper heating element/wire UW to form a bottom of a fresh plastic bag G to be lined/fitted into the bucket B after the filled/sealed trash bag G has been removed, with the bottom of the fresh plastic bag G separated from the top of the trash bag G in the bucket B. The sealed trash bag G is therefore separated from the liner material M supplied from the liner cartridge C. A cycle of the sealing and cutting operation/procedure is thus completed, with the tilting opening of the bucket B, and leaving the bucket B opened for the user to conveniently remove the sealed trash bag G.

Further safety features are implemented for the sealing/cutting procedure. The sealing mechanism will immediately stop and return to trash can mode if external power is cut during the sealing process, and the sealing mechanism will immediately stop and return to trash can mode if the sealing mechanism is interrupted, whether by mechanical failure or an exterior force against the trash can T. User intervention is then required to reinitiate the sealing/cutting procedure after addressing the source/reason of the interruption. When the sealing mechanism is activated, an indicator light (e.g., an LED) will come on or flash for a period of time to indicate sealing is starting. If manual halting the sealing/cutting process is desired, the user can press the touch sensor button in a predetermined sequence (e.g., 3 times) to stop the sealing/cutting process and return the trash can T into its normal mode.

After sealing/cutting operation, after the full trash bag G is removed from the trash can T and the bin/bucket B is closed, the trash can T will begin to redeploy a new bag G. The suction fan will blow down to deploy a new bag G from the liner cartridge C. If a new bag G is not available, then the trash can T will make an audible error sound and the LED will flash red until the spent/empty liner cartridge C is removed.

The operations of the smart trash can T may be summarized below as an example, in accordance with one exemplary embodiment of the present invention:
a. Plug in power cable, then turn on on/off switch.
b. Use touch sensor TS or motion sensor MS to open lid LD; drop in liner cartridge C; use touch sensor TC or motion sensor MS to close lid LD. The liner cartridge C contains a supply of a continuous tubular plastic material M; the cartridge C sits in a slot near the top of the trash can housing H. (When the lid LD is closing, if there is anything item gets in the way of lid LD closing or motion detected by the motion sensor MS, the lid LD will flip back into opened position; after lid LD closed, the trash can T will initiate deployment of the first trash bag G.)
c. User can start tossing trash into the trash bag G, by using touch sensor TS or motion sensor MS to open lid LD. Lid LD will automatically close when no further trash item is dropped into the trash bag G as detected by the motion sensor MS, or after the user pressed the touch sensor TS.
d. Overfill capacity sensor OS detects position of the trash level after the lid LD is closed. E.g., the sensor OS detects if the trash content level reached within, e.g., about 25 cm below the lid LD. When this level is reached, the trash bag G is deemed to be filled; a warning is triggered (e.g., by beeping sound and/or warning/flashing light).
e. When the trash bag G is detected to be filled, a notification light alerts the user to activate sealing operation.
f. Sealing operation:
   1. Press touch sensor TS for 3 seconds; front door D is pivoted to open to move inner bucket B outwards.
   2. When the bucket B is in fully opened position, the complementary sealing/cutting assembly components are engaged to begin the auto sealing/cutting operation, which takes about 25 seconds. In this fully opened position of the bucket B, the sealing/cutting operation is initiated; the backing block (FIG. 9A) (or heating module HM in FIG. 9B) at the respective rear edge of the bucket B is pressed against the heating module HM (FIG. 9A) (or backing block BB in FIG. 9B) at the front inside edge of the top crown section CW of the housing H, below the liner cartridge C. After sealing and cutting, a ready light comes on to notify user of end of operation.
   3. In the still opened bucket position, the user can remove the sealed trash bag G. After detecting removable of the bag G, the front door D will pivot close to move the bucket B back into the trash can T.
   4. The sensor along the two vertical sides/edges detects whether any item is blocking the closure of the front door D. When detected, the front door D stays opened or return to fully opened position. If the opening of the bucket B is blocked during closure of the front door D, the controller module CC (discussed below) senses a change in the current of the front door D driving motor, and automatically reopens the front door D when a current threshold is met.

A control module CC is provided in the trash can T to control the operations of the various features and functions described above, in response to user input (e.g., via the touch sensor TS, motion sensor MS, wirelessly via an app) and in response to the various safety sensors and location sensors (e.g., NS, GS, OS, GBS), to perform the functions/features in the manner as discussed above. The control module CC may include one or more processors, such as one or more CPUs, ASICs, wifi radios, Bluetooth radios, power supply, A/D and/or D/A converters, capacitors, signal processors, RAM, ROM, and other electronic components, which may be populated on one or more circuit boards. The control module CC may include a plurality of sub-modules, whether contained within a same housing or in separate housings. In the illustrated embodiment, the control module CC is depicted as a single module housing.

In a further embodiment, alternatively or in addition, an application module installed in an electronic device (e.g., a mobile phone) may be used to generate remote-control signal, and further to include additional ‘smart’ monitoring and/or control functions for operations of the trash can T. For example, trash can operations may be controlled using an “app” installed in a mobile phone by pairing with the controller. E.g., with the lid LD in opened position, long press the touch sensor for 10 seconds to initiate wifi pairing mode. After pairing, user can control and/or configure operation of the trash can T via an app on a mobile device

While the present invention has been described above in connection with the illustrated embodiments, the scope of patent invention covers all possible present and future variations and improvements that is apparent from the disclosure above. While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the claims.

1. A smart trash can, comprising:
a housing comprising a housing base, a housing back at a rear of the housing, a housing door at a front of the housing, a housing wall at each of left and right sides of the housing, and a crown of the housing having a lid, wherein the housing base, the housing back, the housing door, the housing walls, and the crown define an interior of the housing, wherein the bottom edge of the front housing door is pivotally support on the housing base and configured to be pivotable to tilt with respect to the housing base and away from the housing back to a tilted open position,
a bucket received in the interior of the housing, wherein the bucket has an opened interior space defined by a front side attached to the housing door, a rear side, two lateral sides and a bottom, wherein the bucket is tilted along with tilting of the housing door, wherein the housing door in the tilted open position allows user access to the interior of the bucket;
a liner cartridge supported below the lid within the crown of the housing, wherein the liner cartridge comprises an annular cartridge housing defining an internal annular space and a central opening at a center of the annular cartridge housing, wherein the annular space stores a supply of a continuous tubular length of plastic liner material to be used to line the interior walls of the bucket to form trash bags, wherein the plastic liner material extends from the annular space through the central opening of the liner cartridge to depend below the liner cartridge to line the interior space of the bucket, wherein a depending bottom end of the liner material is sealed, thereby defining a trash bag extending to the bottom, lining the interior of the bucket and having an opening below the central opening of the liner cartridge for receiving trash;
a trash bag sealing and cutting mechanism, configured to seal a top opening of a filled trash bag in the bucket and separate the liner material supplied and extending from the liner cartridge upon tilting the housing door to the tilted open position, and to seal an open bottom end of the liner material supplied and extending from the liner cartridge to prepare for a next trash bag;
a bag relining mechanism configured to line the interior walls of the bucket with the liner material having the sealed bottom end to form a fresh trash bag,
wherein the filled trash bag is replaced by the fresh trash bag upon removal of the filled trash bag from the bucket and closure of the housing door from its tilted open position.
